(19) United States
(12) Patent Application Publication
(10) Pub. No.: US 2026/0101257 A1
(43) Pub. Date: Apr. 9, 2026

(54) REPLACING NETWORK SLICES IN A WIRELESS COMMUNICATION NETWORK

(71) Applicant: Lenovo (Singapore) Pte. Limited, Singapore (SG)

(72) Inventors: Genadi Velev, Darmstadt (DE); Dimitrios Karampatsis, Ruislip (GB)

(73) Assignee: Lenovo (Singapore) Pte. Limited, Singapore (SG)

(21) Appl. No.: 19/113,292

(22) PCT Filed: Dec. 22, 2022
(86) PCT No.: PCT/EP2022/087649

§ 371 Date: Mar. 19, 2025

(30) Foreign Application Priority Data
Nov. 14, 2022 (GR) 20220100935

(51) Int. Cl. H04W 36/00; H04W 48/18; H04W 76/20

(52) U.S. Cl. CPC H04W 36/13; H04W 48/18; H04W 76/20

(57) ABSTRACT

There is further provided a method for a first network function “NF” to determine a replacement of a network slice. The method comprises: receiving a request from a second NF for notification of when a network slice is to be replaced; determining that the network slice is to be replaced and determining an alternative network slice to replace it; and transmitting a notification message to the second NF comprising a notification that the network slice is to be replaced.

### FIELD

The subject matter disclosed herein relates generally to the field of replacing network slices in a wireless communication network. This document defines a first network function “NF” for wireless communication, a method for a first NF to determine a replacement of a network slice, a second NF for wireless communication, and a method for a second NF to determine a replacement of a network slice.

### BACKGROUND

In wireless communication networks, a feature of the 5th generation (5G) of network systems (also abbreviated as 5GS) is that of Network Slicing. Network Slicing enables a network operator to divide (“slice”) the network resources into a finer granularity of logical networks, called network slices. Such network slices may provide customized network connectivity (or network features) towards customers or application service providers.

The network slice is a logical network that comprises a set of network functions and corresponding resources (e.g. computing, storage, networking) necessary to provide certain network capabilities and network characteristics. A network slice can include the Core Network (5G core network, 5GC) control plane and user plane Network Functions (NFs) and Access Network (e.g. 5G radio access network or fixed access network).

The user equipment (UE) can be configured with network slice relevant information, which is referred as Network Slice Selection Assistance information (NSSAI). The NSSAI may consist of single or multiple S-NSSAIs (Single Network Slice Selection Assistance information). The UE requests registration to network slices by sending to the 5GC (e.g. AMF) a NAS registration request message including a Requested NSSAI containing a list of one or more S-NSSAIs to which the UE wants to register. The 5GC (e.g. AMF) may send to the UE in the registration accept message or in UE configuration update command message one or more of the following elements related to the network slice configuration of the UE: allowed NSSAI, configured NSSAI, rejected NSSAI or pending NSSAI. The NSSAI is a list of one or more S-NSSAIs.

### SUMMARY

If an existing network slice or network slice instance cannot serve a particular PDU session, or if the existing network slice instance cannot meet the performance requirements of the applications using it, the network operator may wish to replace this network slice with an alternative network slice. Such a replacement may be temporary. The network slice that is to be replaced may be identified by an old/previous/first S-NSSAI (also referred as S-NSSAI #1). The alternative network slice may be identified by an alternative S-NSSAI (also referred as S-NSSAI #2). In a specific scenario when the UE is roaming in a visited PLMN (e.g. V-PLMN), the UE may use home-route PDU Sessions where the PDU Session is anchored in the home PLMN (e.g. H-PLMN) and the PDU Session is setup over one S-NSSAI in the V-PLMN and another S-NSSAI in the H-PLMN. The H-PLMN should be able to replace the S-NSSAI used in the H-PLMN. Whether roaming or not, there is a need for the AMF to know that the first network slice needs to be replaced with an alternative network slice.

Disclosed herein are procedures for replacing network slices in a wireless communication network. Said procedures may be implemented by a first network function “NF” for wireless communication, a method for a first NF to determine a replacement of a network slice, a second NF for wireless communication, and a method for a second NF to determine a replacement of a network slice.

There is provided a first network function “NF” for wireless communication, comprising a processor; and a memory coupled with the processor, the processor configured to cause the apparatus to determine a replacement of a network slice by: receiving a request from a second NF for notification of when a network slice is to be replaced; determining that the network slice is to be replaced and determining an alternative network slice to replace it; and transmitting a notification message to the second NF comprising a notification that the network slice is to be replaced. The first network function may comprise a Network Slice Selection Function (NSSF). The second NF may be an Access and Mobility Management Function (AMF).

There is further provided a method for a first network function “NF” to determine a replacement of a network slice. The method comprises: receiving a request from a second NF for notification of when a network slice is to be replaced; determining that the network slice is to be replaced and determining an alternative network slice to replace it; and transmitting a notification message to the second NF comprising a notification that the network slice is to be replaced.

There is further provided a second network function “NF” for wireless communication, comprising: a processor; and a memory coupled with the processor. The processor is configured to cause the apparatus to determine a replacement of a network slice by: sending a request to a first NF for notification of when a network slice is to be replaced; and receiving a notification message from the first NF comprising a notification that the network slice is to be replaced.

There is further provided a method for a second network function “NF” to determine a replacement of a network slice, the method comprising: sending a request to a first NF for notification of when a network slice is to be replaced; and receiving a notification message from the first NF comprising a notification that the network slice is to be replaced.

The methods and apparatus defined herein provide a mechanism by which a second network function, such as an AMF, may be informed of a change in network slice. Such a mechanism improves the operation of a wireless communication network by facilitating a change to an alternative network slice when a network slice of a first set of network slices needs to be replaced. This mechanism tends to ensure that a PDU Session established on a network slice is transferred to an alternative network slice and which may ensure service continuity, and which might include maintaining a quality of service.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for replacing network slices in a wireless communication network will now be described, by way of example only, with reference to the accompanying drawings, in which:

FIG. 1 depicts an embodiment of a wireless communication system for replacing network slices in a wireless communication network;

FIG. 2 depicts a user equipment apparatus that may be used for implementing the methods described herein;

FIG. 3 depicts further details of the network node that may be used for implementing the methods described herein;

FIG. 4 shows an example 5GS architecture for a UE associated with two network slices;

FIG. 5 shows an architecture which can be applied for the solutions described herein where a UE is associated with two network slices;

FIG. 6 illustrates a signaling flow for a procedure to trigger S-NSSAI replacement by an NSSF;

FIG. 7 illustrates a method for a first network function “NF” to determine a replacement of a network slice; and

FIG. 8 illustrates a method for a second network function “NF” to determine a replacement of a network slice.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions /cts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

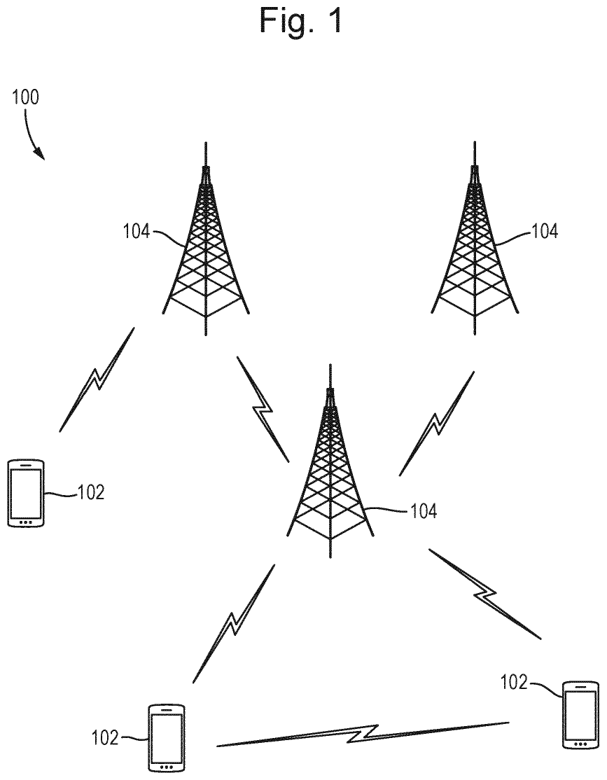

FIG. 1 depicts an embodiment of a wireless communication system 100 for replacing network slices in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”'), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

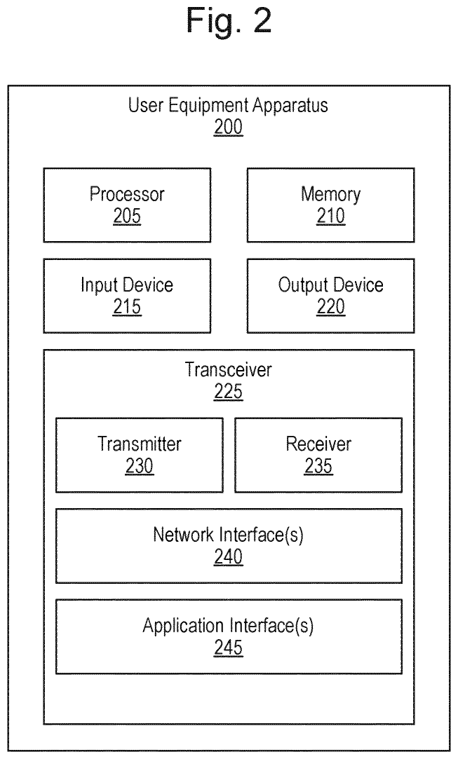

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102 or may be implemented as a UE 410 or UE 610 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

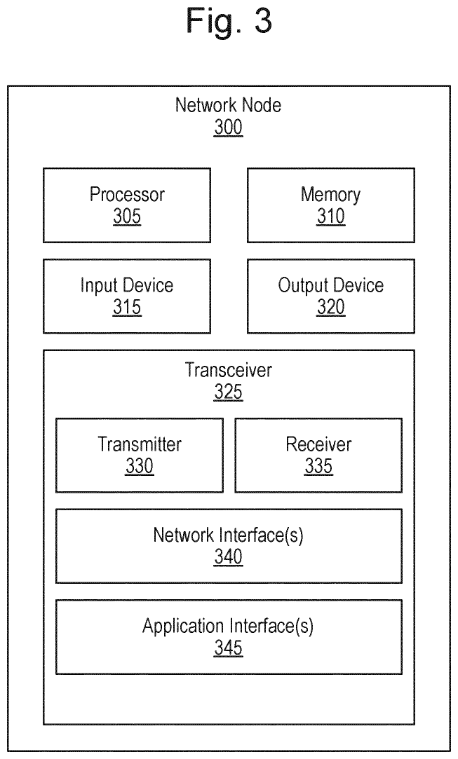

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a network unit 104 or may be implemented as one of the network functions described herein. In particular, network node 300 may be an implementation of an AMF 520, a V-NSSF 532, an H-NSSF 534, an AMF 620, a V-NSSF 632, an H-NSSF 634, or a V-SMF 652 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

A feature of the 5th generation (5G) of network systems (also abbreviated as 5GS) is that of Network Slicing. Network Slicing enables a network operator to divide (“slice”) the network resources into a finer granularity of logical networks, called network slices. Such network slices may provide customized network connectivity (or network features) towards customers or application service providers.

The network slice is a logical network that comprises a set of network functions and corresponding resources (e.g. computing, storage, networking) necessary to provide certain network capabilities and network characteristics. A network slice can include the Core Network (5G core network, 5GC) control plane and user plane Network Functions (NFs) and Access Network (e.g. 5G radio access network or fixed access network).

The user equipment (UE) can be configured with network slice relevant information, which is referred to as Network Slice Selection Assistance information (NSSAI). The NSSAI may consist of single or multiple S-NSSAIs (Single Network Slice Selection Assistance information). The UE requests registration to network slices by sending to the 5GC (e.g. AMF) a NAS registration request message including a Requested NSSAI containing a list of one or more S-NSSAIs to which the UE has identified a need to register. The 5GC (e.g. AMF) may send to the UE in the registration accept message or in UE configuration update command message one or more of the following elements related to the network slice configuration of the UE: allowed NSSAI, configured NSSAI, rejected NSSAI or pending NSSAI. The NSSAI is a list of one or more S-NSSAIs.

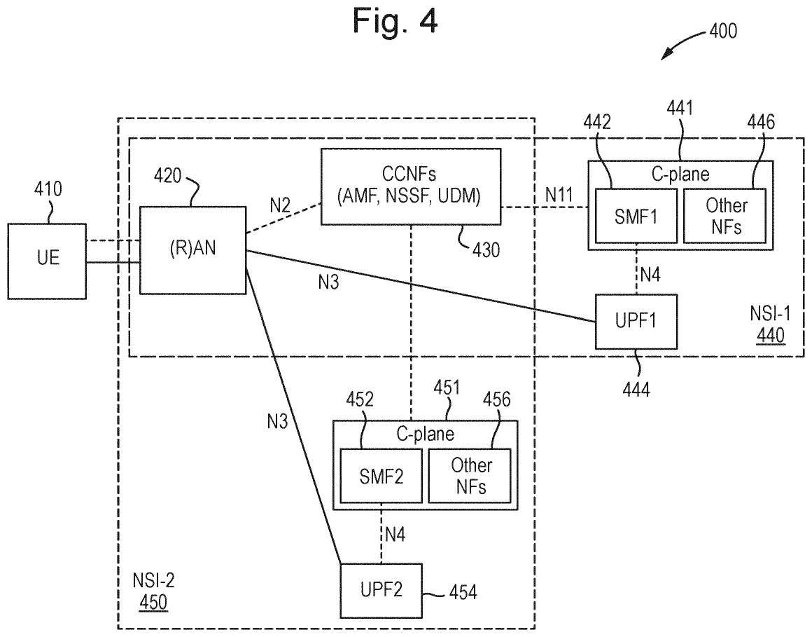

FIG. 4 shows an example 5GS architecture 400 for a UE 410 associated with two network slices 440, 450. The network slices are deployed correspondingly over network slice instance-1 440 (e.g. “NSI-1”) depicted by a dashed line in FIG. 4 and network slice instance-2 450 (“NSI-2”) depicted by a dotted line in FIG. 4. According to this example architecture 400 the (radio) access network ((R)AN) 420 is part of the two slices 440, 450 and so is shared. The core network (CN) part 430 of the network slices (or NSIs) 440, 450 has a Common Control Plane Network Functions (CCNFs). Each network slice has dedicated CN Network Functions like SMF1 442, UPF1 444, and other NFs 446 belonging to NSI-1 440 and SMF2 452, UPF2 454 and other NFs 456 belonging to NSI-2 450.

FIG. 4 also illustrates the interfaces used for communication between the different functions, these interfaces are labeled N2, N3, N4 and N11. Note that FIG. 4 does not include all NFs and all reference points. More information about the functionality of the NFs (e.g. AMF, NSSF, SMF, UPF, etc.), the reference points and the 5GS can be found in: 3GPP TS 23.501, V17.6.0, 2022 September, “System Architecture for the 5G System”; and 3GPP TS 23.502, V17.6.0, 2022 September, “Procedures for the 5G System”.

3GPP TR 23.700-41, V1.1.0, 2022October, “Study on enhancement of network slicing, Phase 3, (Release 18)” addresses some scenarios and presents some candidate solutions on the support of network slice service continuity during UE mobility due to no support of the network slice or resource limitation of the network slice in the target RAN node. Those scenarios may happen due to the fact that network slices are not required to be available in all tacking areas (TAs) of a network, and the focus of these solutions was to enable slice re-mapping within a radio access network (RAN) or based on deployment improvements.

The following scenarios (or events) may happen in the network which lead to a need for change of network slice, e.g. a first network slice (S-NSSAI-1) may need to be exchanged with a second network slice (S-NSSAI-2):
No mobility scenario 1: network slice or network slice instance is overloaded or undergoing planned maintenance in CN (e.g., network slice termination);
No mobility scenario 2: network performance of the network slice cannot meet the SLA agreed with the network slice customer and therefore the UE should use another network slice which would better fulfil the SLA;
Mobility scenario, especially in case of Inter-registration area (RA) mobility where a network slice or network slice instance is overloaded in the target CN.

If an existing network slice or network slice instance cannot serve a particular PDU session, or if the existing network slice instance cannot meet the performance requirements of the applications using it, the network operator may wish to replace this network slice with an alternative network slice. Such a replacement may be temporary. The network slice that is to be replaced may be identified by an old/previous/first S-NSSAI (also referred as S-NSSAI #1). The alternative network slice may be identified by an alternative S-NSSAI (also referred as S-NSSAI #2). In a specific scenario when the UE is roaming in a visited PLMN (e.g. V-PLMN), the UE may use home-route PDU Sessions where the PDU Session is anchored in the home PLMN (e.g. H-PLMN) and the PDU Session is setup over S-NSSAI in the V-PLMN and an S-NSSAI in the H-PLMN. The UE's allowed NSSAI contain the V-PLMN S-NSSAI and the mapping of the V-PLMN S-NSSAI to the H-PLMN S-NSSAI. There are scenarios where the H-PLMN should be able to replace the S-NSSAI used in the H-PLMN. It is currently unclear how the H-PLMN can trigger the (temporary) replacement of the H-PLMN S-NSSAI with an alternative H-PLMN S-NSSAI. Whether roaming or not, there is a need for the AMF to know that the first network slice needs to be replaced with an alternative network slice.

3GPP TR 23.700-41, V1.1.0, 2022 October, “Study on enhancement of network slicing, Phase 3, (Release 18)” describes two solutions as to how a network slice replacement can be triggered.

In a first solution, the AMF asks for assistance information from the PCF, which is assumed to be the Access and Mobility management PCF, e.g. AM-PCF. A drawback of this solution is that the AM-PCF uses a per UE association signaling exchange with the AMF which means that the AM-PCF needs to signal a need for S-NSSAI replace for each UE individually. Another drawback is that the AM-PCF in the V-PLMN does not know the situation of a particular network slice in the H-PLMN, and thus, cannot initiate replacement of H-PLMN S-NSSAI.

In a second solution, the PCF responsible for the session management, e.g. SM-PCF, in the H-PLMN triggers the SMF in the H-PLMN (e.g. H-SMF) to initiate the re-establishment of the existing PDU Session over an alternative S-NSSAI. A drawback of this solution is that it uses on a per UE basis signaling, instead of per S-NSSAI signaling. Furthermore, it is not clear how the SM-PCF in the H-PLMN is made aware of the alternative S-NSSAI as the SM-PCF does not know the network slice configuration in the network. Additionally, if the NAS SM signaling is used to indicate to the UE that the old H-PLMN S-NSSAI is to be replaced by an alternative S-NSSAI, the AMF (in the V-PLMN) is not aware of the alternative S-NSSAI and the alternative S-NSSAI cannot be included in the new Allowed NSSAI.

It should also be noted that in a roaming case, it is currently unclear how the H-PLMN can trigger the (temporary) replacement of the H-PLMN S-NSSAI with an alternative H-PLMN S-NSSAI.

There is provided herein a method to trigger the (perhaps temporary) replacement of a network slice (e.g. identified by S-NSSAI) due to mobility or non-mobility scenarios as described above. It is assumed that the old/first S-NSSAI should be replaced as whole, e.g. due to decommissioning of the network slice, for example due to maintenance. The methods and apparatus described herein advantageously minimize signaling overhead by signal the replacement of the old S-NSSAI with an alternative S-NSSAI on a network slice basis instead of signaling on a per UE basis.

As described herein, a network slice selection function (NSSF) determines that (possibly only temporary) replacement of an old network slice (S-NSSAI) is required, and further, the NSSF determines which alterative network slice (S-NSSAI) value is to be used. Specific to a roaming scenario, a V-NSSF can request the H-NSSF to notify when and/or whether the H-PLMN S-NSSAI should be replaced by an alternative H-PLMN S-NSSAI. The proposed solution may be characterized by the following salient features: As described herein, the NSSF may determine that (temporary) replacements of an old S-NSSAI is required; determine the alternative S-NSSAI value; and notify the AMF that a currently used S-NSSAI should be replaced by the alternative S-NSSAI value.

The NSSF may determine that (temporary) replacement of an old S-NSSAI is required based on:
a local trigger in the NSSF, including a trigger from the operations and maintenance (OAM) system;
analytics received from the NWDAF; and/or
an indication received from the NEF or AF.

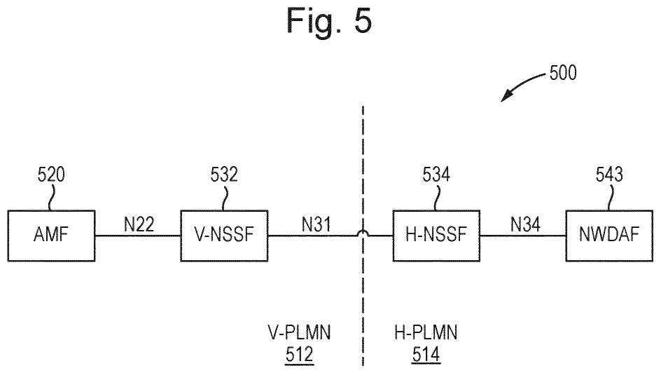

FIG. 5 shows an architecture 500 which can be applied for the solutions described herein where a UE is associated with two network slices, i.e. one in the V-PLMN and one in the H-PLMN. FIG. 5 shows an AMF 520, a V-NSSF 532, an H-NSSF 534, and an NWDAF 543. The AMF 520 is connected with the NSSF, in roaming case with the visited NSSF 532 (e.g. V-NSSF), via the N22 reference point (or also called interface). The V-NSSF 532 is connected with the NSSF in the home PLMN 514 (e.g. H-NSSF 534) via the N31 reference point. The H-NSSF 534 is connected with the network data analytics function (NWDAF) 543 in the H-PLMN 514 via the N34 reference point.

The NSSF supports the following functionality:
Selecting the set of Network Slice instances serving the UE;
Determining the Allowed NSSAI and, if needed, the mapping to the Subscribed S-NSSAIs;
Determining the Configured NSSAI and, if needed, the mapping to the Subscribed S-NSSAIs;
Determining the AMF Set to be used to serve the UE, or, based on configuration, a list of candidate AMF(s), possibly by querying the NRF;
The NSSF may provide support for Network Slice restriction and Network Slice instance restriction based on NWDAF analytics.

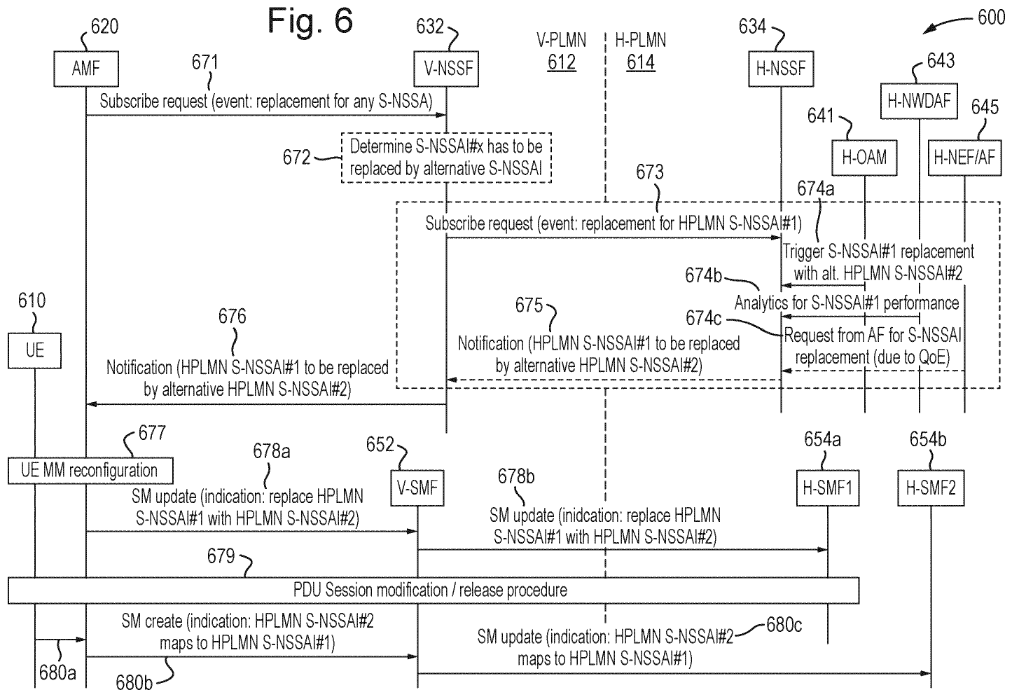

In addition to the above, the NSSF described herein provides the following additional functionality:
Determining that an (old/first) S-NSSAI has to be replaced by alternative S-NSSAI; and additionally the alternative S-NSSAI value. The determination may be based on new data analytics received from the NWDAF about the overload or congestion (e.g. in user plane or in control plane) of the S-NSSAI or the inability of the S-NSSAI to fulfil the service level agreements (SLA) negotiated for the services offered by the S-NSSAI.
Offering a notification service to consumer NFs (e.g. AMF, V-NSSF) to indicate that (1) the old S-NSSAI needs to be (e.g. temporary) replaced by the alternative S-NSSAI and (2) the replacement is terminated and the old S-NSSAI can be used again. This includes the triggering of the S-NSSAI replacement procedure as described below with reference to FIG. 6.

Please note that an “alternative” S-NSSAI feature, or a “compatible” S-NSSAI feature, means functionality supported by the network and UE where a first S-NSSAI of a PDU Session can be exchanged with another (second) S-NSSAI, wherein the second S-NSSAI may either be part of the network slice currently configured for the UE or may not be part of the network slice currently configured for the UE. The alternative S-NSSAI may be denoted as S-NSSAI #2, whereas the S-NSSAI to be replaced is denoted as S-NSSAI #1. In case of roaming, the notions H-PLMN S-NSSAI #1 and H-PLMN S-NSSAI #2 are used to show that these are the network slices in the H-PLMN.

It should also be noted that where this document uses the term PLMN with reference to a public network, the solution described herein may also apply to non-public networks, e.g. SNPNs.

FIG. 6 illustrates a signaling flow 600 for a procedure to trigger S-NSSAI replacement by an NSSF. The signaling flow 600 includes an AMF requesting the NSSF to inform the AMF when the replacement of an S-NSSAI is required. This figure shows a roaming case with visited PLMN (V-PLMN) 612 and home PLMN (H-PLMN) 614.

However, the present method is also applicable in non-roaming case when only a single NSSF is used. The notion “H-” in front of the name of network function (NF) means that the NF is located in the H-PLMN 614, whereas the notion “V-” in front of the name of NF means that the NF is located in the V-PLMN 612.

FIG. 6 illustrates a UE 610, an AMF 620, a V-NSSF 632, an H-NSSF 634, an H-OAM 641, an H-NWDAF 643, and an H-NEF/AF 645, a V-SMF 652, an H-SMF1 654a and an H-SMF2 654b. The process 600 commences at step 671, the AMF 620 serves one or more network slices. There are one or more UEs registered in the AMF 620, wherein the AMF 620 maintains UEs'mobility management (MM) contexts and the MM contexts contain allowed NSSAI having a set of S-NSSAIs. The AMF 620 may request/subscribe with the (V-)NSSF 632 to be notified about the event (or need) that one or more currently offered network slices (e.g. a set of S-NSSAIs offered or served by the AMF) need to be replaced (or exchanged) with one or more alternative network slices.

For example, the AMF 620 may use the Nnssf_NSSAIAvailability_Subscribe service operation and include a new parameter or a new event indicating whether replacement of any of the S-NSSAI part of the set of S-NSSAIs is required. In another example, the AMF 620 may use a new service operation to request the notification from the NSSF. For example, in case of roaming UEs, the AMF 620 may indicate whether the V-PLMN S-NSSAI and/or the H-PLMN S-NSSAI (e.g. S-NSSAI #1) should be monitored for replacement. Generally, the AMF 620 may request a set of network slices (i.e. a list of S-NSSAIs) for which replacement notification should be provided by the NSSF 632. The set of network slices corresponds to the network slices which are served by the AMF.

In addition or alternatively, the AMF 620 may only subscribe for notifications for H-PLMN S-NSSAIs when there are (e.g. inbound roaming) UEs served by the AMF 620 which use PDU Sessions for Home-routed (HR) traffic. If the UE's “SMF Selection Subscription data” indicates that home-route traffic for a specific S-NSSAI is preferred (i.e. LBO is not allowed), the AMF 620 determines that H-PLMN S-NSSAI would be involved and the AMF 620 determines to subscribe with the NSSF for the replacement of the H-PLMN S-NSSAI, optionally in addition to subscribing for the replacement of the V-PLMN S-NSSAIs. In other words, for (e.g. inbound roaming) UEs using local-break-out (LBO) sessions, the AMF 620 does not need to subscribe for notifications related to the H-PLMN S-NSSAI replacement.

The AMF 620 may determine to connect with a specific NSSF which supports the new functionality of triggering the S-NSSAI replacement procedure. For this purpose, the NSSF supporting the new functionality may register its new functionality with the NRF. The AMF 620 request from the NRF to resolve an NSSF supporting the functionality of S-NSSAI replacement triggering. The NRF would return to the AMF 620 one or more NSSFs which support the new functionality.

At 672, in a non-roaming case (i.e. for S-NSSAIs served by the V-PLMN 612), the NSSF 632 may determine that an original and/or old S-NSSAI (i.e. V-PLMN S-NSSAI) needs to be replaced. The NSSF determines also the alternative S-NSSAI which replaces the original/old S-NSSAI. The NSSF may receive triggers for replacement of the original/old S-NSSAI by any of the means described in the steps 674a, 674b or 674c, described in detail below, with the difference that the OAM System, NWDAF and NEF/AF are located in the V-PLMN, i.e. in the same network where the NSSF is located.

If the NSSF determines that the original/old S-NSSAI is to be replaced, the NSSF proceeds with step 676.

At 673, in a roaming case, when there are UEs registered with S-NSSAIs from the H-PLMN 614 (i.e. H-PLMN S-NSSAI), the (V-)NSSF 632 may discover an NSSF in the H-PLMN (i.e. H-NSSF 634) and establish a signaling association with the H-NSSF 634. The (V-)NSSF 632 may use the Nnssf_NSSAIAvailability_Subscribe service operation and include a new parameter or a new event indicating whether replacement of any of the S-NSSAI part of the set of S-NSSAIs is required.

At 674, the H-NSSF 634 may locally determine that an original/old S-NSSAI #1 becomes unavailable (or cannot fulfil the SLAs) and may determine that the S-NSSAI has to be replaced. The AMF 620 may in addition determine an alternative S-NSSAI (e.g. S-NSSAI #2) which should replace S-NSSAI #1. The reason why S-NSSAI #1 becomes unavailable can be a non-mobility event (e.g. OAM or NF reconfiguration, S-NSSAI #1 will be down due to network maintenance.

The AMF 620 may use one of the following inputs or procedures to obtain information in order to trigger the S-NSSAI #1 replacement:
674a: The OAM system 641 of the H-PLMN 614 may trigger S-NSSAI #1 replacement with alternative S-NSSAI #2.
674b: The NSSF may have subscribed with the NWDAF 643 to receive new data analytics about the overload or congestion (e.g. in user plane or in control plane) of the S-NSSAI or the inability of the S-NSSAI to fulfil the service level agreements (SLA) negotiated for the services offered by the S-NSSAI.
674c: The NSSF may receive a request from an application function (AF) 645 directly or via network exposer function (NEF) 645 for the need to replace the S-NSSAI #1. One reason for the AF 645 to trigger temporary replacement of the S-NSSAI #1 can be that the quality of experience (e.g. QoE) is not satisfied. The request from the AF or NEF 645 may in addition contain the S-NSSAI #2 which replaces the S-NSSAI #1.

Upon or more of the trigger events in 674a, 674b or 674c, the (H-)NSSF 634 may be able to determine alternative network slice (e.g. S-NSSAI #2) which can replace S-NSSAI #1. The (H-)NSSF 634 determines the alternative S-NSSAI #2 based on local configuration or stored input from various AMFs (from the same PLMN, e. g H-PLMN in this case) about the available S-NSSAIs and their tracking area deployment.

At 675, the H-NSSF 634 sends a notification to the (V-)NSSF 632 to indicate that the H-PLMN S-NSSAI #1 is to be replaced by alternative H-PLMN S-NSSAI #2. The H-NSSF 634 may also send the H-PLMN NRF responsible for the resolution of the NFs in the alternative H-PLMN S-NSSAI #2. The Nnssf_NSSAIAvailability_Notify service operation can be used for this purpose with new parameters indicating that H-PLMN S-NSSAI #1 to be replaced by alternative H-PLMN S-NSSAI #2. Alternatively, a new notification message may be used for this purpose. Please note that the H-NSSF would also notify the AMFs in the H-PLMN about the need to replace the S-NSSAI #1, however this is not shown in the figure, as the notification to the AMFs in the same network (e.g. H-PLMN in this case) is shown in step 676.

At 676, the (V-)NSSF 632 sends to the AMF 620 a notification to indicate that either (1) the V-PLMN S-NSSAI is to be replaced if the NSSF is triggered by step 672, or (2) in case of roaming the H-PLMN S-NSSAI #1 is to be replaced if the NSSF is triggered by step 675. In addition, the NSSF may indicate to the AMF the alternative S-NSSAI (e.g. alternative V-PLMN S-NSSAI or alternative H-PLMN S-NSSAI #2). In roaming case, the NSSF may also include the H-PLMN NRF responsible for the resolution of the NFs in the alternative H-PLMN S-NSSAI #2. The Nnssf_NSSAIAvailability_Notify service operation can be used for this purpose with new parameters indicating that a specific S-NSSAI (e.g. V-PLMN S-NSSAI or H-PLMN S-NSSAI #1) is to be replaced by alternative H-PLMN S-NSSAI #2. Alternatively, a new notification message may be used for this purpose.

When a network slice replacement for e.g. S-NSSA #1 (e.g. being a V-PLMN S-NSSAI or H-PLMN S-NSSAI) is triggered by the NSSF and the alternative network slice is S-NSSAI #2, the AMF 620 determines that the existing established PDU Sessions on the S-NSSA #1 should be transferred to the alternative network slice S-NSSAI #2. Here, “transfer of PDU Sessions” means that the PDU Sessions may be re-established on the alternative network slice S-NSSAI #2 (e.g. being alternative V-PLMN S-NSSAI or alternative H-PLMN S-NSSAI).

At 677, the AMF 620 may trigger network slice configuration update to the UE 610, e.g. by using UE configuration update (UCU) procedure. The AMF 620 may update the Allowed NSSAI, Configured NSSAI, Rejected NSSAI in the UE 610.

The AMF 620 may send to the UE 610 at least one of the following information (e.g. as part of the Allowed NSSAI):
The V-PLMN S-NSSAI in the Allowed NSSAI;
The mapping of the V-PLMN S-NSSAI to the alternative H-PLMN S-NSSAI #2; and
The mapping/replacement of the alternative H-PLMN S-NSSAI #1 to the H-PLMN S-NSSAI #2.

Note that the AMF 620 may also send to the NSSF a request for: a new configured NSSAI, allowed NSSAI (e.g. comprising the S-NSSAI-2) and/or rejected NSSAIs. The AMF 620 may include in the request message as input parameters the associated mapping information of S-NSSAI #2 to S-NSSAI #1.

At 678a, (which may be performed after a successful step 677, or in parallel to step 677) the AMF 620 performs internal check to figure out whether there are established PDU Sessions (e.g. home-routed PDU Sessions) associated with the S-NSSAI to be replaced, e.g. H-PLMN S-NSSAI #1. If yes, the AMF 620 may send signaling to the anchor SMF (e.g. H-SMF1 654a) of the PDU Sessions to trigger the anchor SMF to release or modify the PDU Session due to the replacement of the S-NSSAI (e.g. replacement of H-PLMN S-NSSAI #1). The AMF 620 sends to the anchor SMF signaling request for session management to update the H-SMF (654a or 654b) that the PDU Session needs to be reallocated on a different S-NSSAI. The AMF 620 includes an indication that the PDU Session needs to be reallocated from H-PLMN S-NSSAI #1, and/or in addition the H-PLMN S-NSSAI #2 may be included. The AMF 620 can use Nsmf_PDUSession_UpdateSMContext request service operation to trigger this step.

At 678b, in a roaming scenario, the V-SMF 652 forwards the message received in step 677a (Nsmf_PDUSession_UpdateSMContext request) to the H-SMF (e.g. H-SMF1 654a).

At 679, the H-SMF determines to trigger the release of the PDU Session (e.g. in case the PDU Session is of type SSC mode 1 or 2) or the PDU Session modification (e.g. in case the PDU Session is of type SSC mode 3). The H-SMF 654a sends NAS SM signaling to the UE to release or to modify the PDU session by establishing a new PDU Session over an appropriate S-NSSAI.

At 680a, the UE 610 requests the establishment of a new PDU Session towards the including the mapping of the H-PLMN S-NSSAI #2 to H-PLMN S-NSSAI #1.

At 680b, the AMF 620 selects an anchor SMF (e.g. H-SMF2 654b) in the network slice identified by the H-PLMN S-NSSAI #2. The AMF 620 may use the NRF service in the H-PLMN, where the AMF 620 may know the NRF identity in the H-PLMN from step 676. During the new PDU Session establishment, the AMF 620 uses the alternative S-NSSAI (e.g. alternative H-PLMN S-NSSAI #2) to resolve the H-SMF for the HR PDU Session. The AMF 620 uses this H-PLMN NRF to resolve the new SMF in the H-PLMN (e.g. H-SMF2 654b) which is to be used in the alternative H-PLMN S-NSSAI #2 as indicated in step 676.

The AMF 620 sends to the V-SMF 652 a session management request message to create a new PDU Session, whereby the AMF 620 may include an indication that H-PLMN S-NSSAI #2 maps to H-PLMN S-NSSAI #1. For example, the AMF 620 may use Nsmf_PDUSession_CreateSMContext request service operation.

At 680c, the V-SMF 652 forwards the message received in step 680b further to the H-SMF2 654b.

Note that the described solution applies also to scenarios where the UE is registered with the S-NSSAI #1 and there is no PDU Session established on S-NSSAI #1.In other words, as long as the AMF 620 maintains any UE context with Allowed NSSAI which includes S-NSSAI #1 (or H-PLMN S-NSSAI #1), the AMF 620 may subscribe/request to be notified by the (V-)NSSF when the S-NSSAI #1 (or H-PLMN S-NSSAI #1) has to be replaced.

A benefit of the solution described herein is that the (temporary) replacement of a network slice is monitored, maintained and determined in the NSSF which has a global overview of the deployment of the network slices in the network (e.g. PLMN or SNPN). The AMF 620 request/subscribes for notifications from the NSSF when the NSSF determines that the replacement of an S-NSSAI is needed. The NSSF in the serving network (e.g. V-NSSF 632) can exchange with the NSSF in the home network (e.g. H-NSSF 634) in order to determine the need to replace the S-NSSAI in the home network 614.

In a further embodiment, the NSSF may determine that a network slice (e.g. S-NSSAI #1), for which a replacement has been determined and notified to the AMF, does not need to be replaced anymore. In other words, the NSSF determines that the replacement of S-NSSAI #1 with S-NSSAI #2 can be terminated and the S-NSSAI #1 can be normally used.

In such a situation, the method performed by the NSSF comprises:
Determining that the replacement of S-NSSAI #1 with S-NSSAI #2 can be terminated and that the S-NSSAI #1 can be normally used. This is similar to steps 672 or 674 from FIG. 6, wherein the NSSF determines that the S-NSSAI #1 is available again for use without replacement. In one example, this determination can be based on new or existing network data analytics received from the NWDAF indicating the network slice availability or low load/congestion of the S-NSSAI #1.
Transmitting a notification to the consumer NF (e.g. AMF 620 or V-NSSF 632) that the replacement of S-NSSAI #1 is not required or that it is terminated. This is similar to steps 675 or 676 from FIG. 6, wherein the parameter in the notification message indicates that S-NSSAI #1 can be used again without need to replace it.
Continues to monitor whether replacement of the network slice or other network slices is required.

When the AMF receives a notification that the replacement of the network slice is terminated, the AMF creates a new allowed NSSAI, configured NSSAI and/or rejected NSSAI wherein the alternative S-NSSAI (e.g. S-NSSAI #2) is removed from the allowed NSSAI or configured NSSAI, and the mapping of the S-NSSAI #2 to the S-NSSAI #1 is also removed. The S-NSSAI #1 can be included in the allowed NSSAI and/or configured NSSAI as in the case before the S-NSSAI replacement procedure has been performed. The AMF triggers the network slice configuration procedure to the UE. The AMF may use the UCU procedure for this purpose as shown in step 677 in the FIG. 6.

Furthermore, the AMF triggers update procedure to the anchor SMFs which serve the PDU Session associated with the alternative S-NSSAI #2. The AMF may indicate to the anchor SMF that the PDU Session on the S-NSSAI #2 has to be terminated and re-established on the S-NSSAI #2. In one example, this is the same procedure as shown in FIG. 6 steps 678, 679 and 680, however the parameters in the messages are different:
instead of the indication that the PDU Session needs to be reallocated from S-NSSAI #1 to S-NSSAI #2, the new parameter indicates that the PDU Session needs to be reallocated from S-NSSAI #2 to S-NSSAI #1.
When the UE triggers the re-establishment of the PDU Session in step 680a, the UE does not send the mapping information of S-NSSAI #2 to S-NSSAI #1, as the mapping information should have been deleted in the UE in step 677.

Accordingly, there is provided a first network function “NF” for wireless communication, comprising a processor; and a memory coupled with the processor, the processor configured to cause the apparatus to determine a replacement of a network slice by: receiving a request from a second NF for notification of when a network slice is to be replaced; determining that the network slice is to be replaced and determining an alternative network slice to replace it; and transmitting a notification message to the second NF comprising a notification that the network slice is to be replaced. The first network function may comprise a Network Slice Selection Function (NSSF). The second NF may be an Access and Mobility Management Function (AMF).

The methods defined herein provide a mechanism by which a second network function, such as an AMF, may be informed of a change in network slice. Such a mechanism improves the operation of a wireless communication network by facilitating a change to an alternative network slice when a network slice of a first set of network slices needs to be replaced. This mechanism tends to ensure that a PDU Session established on a network slice is transferred to an alternative network slice and which may ensure service continuity, and which might include maintaining a quality of service. The quality of service may be defined in a service level agreement (SLA).

The request for notification of when the network slice is to be replaced may also include at least one of: a request for an indication of the alternative network slice which is to replace it; and a first set of network slices for which notification has to be provided, wherein the network slice is a member of the first set of network slices. The first set of network slices may comprise a list of network slices. The first set of network slices may comprise a list of S-NSSAIs. The first set of network slices may comprise any network slice which is served by the second NF. Determining that the network slice is to be replaced may comprise determining that at least one network slice from the first set of network slices is to be replaced.

The notification message transmitted to the second NF additionally may comprise an indication of the identity of the alternative network slice.

Determining that the network slice is to be replaced and determining an alternative network slice to replace it in case of roaming may include transmitting a request for notification to a third NF in a home network to request notification of replacement of the network slice. The third NF may comprise a Home NSSF (H-NSSF). The home network may be a Home Public Land Mobile Network (H-PLMN).

Determining that the network slice is to be replaced and determining an alternative network slice to replace it may include: receiving a notification about the unavailability or severe conditions of the network slice from a fourth NF. The fourth NF may comprise a network function, an application function or a Network Data Analytics Function (NWDAF).

The first NF may determine that the network slice which was to be replaced may be used again; and wherein the first NF transmits a notification to the second NF that the network slice which was to be replaced may be used again.

The second NF may be an Access and Mobility Management Function “AMF”. The second NF is a visited Network Slice Selection Function “V-NSSF”.

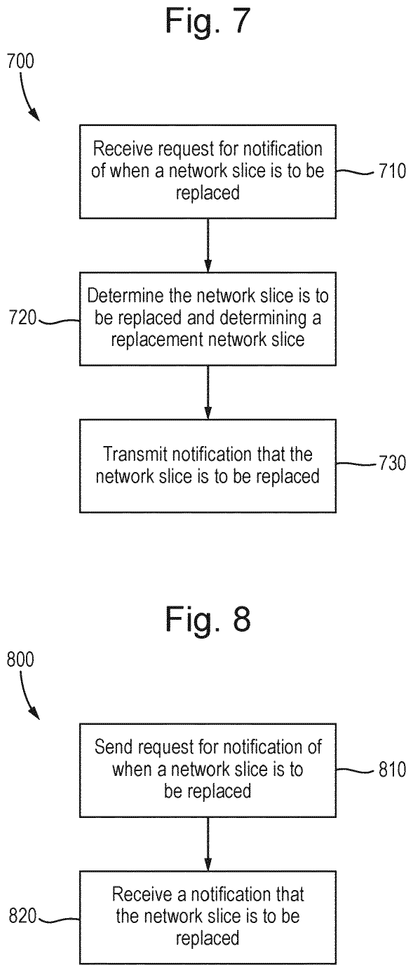

FIG. 7 illustrates a method 700 for a first network function “NF” to determine a replacement of a network slice. The method 700 comprises: receiving 710 a request from a second NF for notification of when a network slice is to be replaced; determining 720 that the network slice is to be replaced and determining an alternative network slice to replace it; and transmitting 730 a notification message to the second NF comprising a notification that a network slice from the first set of network slices is to be replaced.

In certain embodiments, the method 700 may be performed by a processor executing program code, for example, a microcontroller, a microprocessor, a CPU, a GPU, an auxiliary processing unit, a FPGA, or the like.

The methods defined herein provide a mechanism by which a second network function, such as an AMF, may be informed of a change in network slice. Such a mechanism improves the operation of a wireless communication network by facilitating a change to an alternative network slice when a network slice of a first set of network slices needs to be replaced. This mechanism tends to ensure that a PDU Session established on a network slice is transferred to an alternative network slice and which may ensure service continuity, and which might include maintaining a quality of service. The quality of service may be defined in a service level agreement (SLA). The first network function may comprise a Network Slice Selection Function (NSSF). The second NF may be an Access and Mobility Management Function (AMF).

The request for notification of when the network slice is to be replaced may also include at least one of: a request for an indication of the alternative network slice which is to replace it; and a first set of network slices for which notification has to be provided, wherein the network slice is a member of the first set of network slices. The first set of network slices may comprise a list of network slices. The first set of network slices may comprise a list of S-NSSAIs. The first set of network slices may comprise any network slice which is served by the second NF. Determining that the network slice is to be replaced may comprise determining that at least one network slice from the first set of network slices is to be replaced.

The notification message transmitted to the second NF additionally may comprise an indication of the identity of the alternative network slice.

Determining that the network slice is to be replaced and determining an alternative network slice to replace it in case of roaming may include transmitting a request for notification to a third NF in a home network to request notification of replacement of a network slice in the first set of network slices. The third NF may comprise a Home NSSF (H-NSSF). The home network may be a Home Public Land Mobile Network (H-PLMN).

Determining that the network slice is to be replaced and determining an alternative network slice to replace it may include: receiving a notification about the unavailability or severe conditions of the network slice from a fourth NF. The fourth NF may comprise an network function, an application function or a Network Data Analytics Function (NWDAF).

The first NF may determine that the network slice which was to be replaced may be used again; and wherein the first NF transmits a notification to the second NF that the network slice which was to be replaced may be used again.

The second NF may be an Access and Mobility Management Function “AMF”. The second NF may be a visited Network Slice Selection Function “V-NSSF”.

There is further provided a second network function “NF” for wireless communication, comprising: a processor; and a memory coupled with the processor. The processor is configured to cause the apparatus to determine a replacement of a network slice by: sending a request to a first NF for notification of when a network slice is to be replaced; and receiving a notification message from the first NF comprising a notification that the network slice is to be replaced.

The methods defined herein provide a mechanism by which a second network function, such as an AMF, may be informed of a (temporary) change of a network slice. Such a mechanism improves the operation of a wireless communication network by facilitating a change to an alternative network slice when a network slice of a first set of network slices needs to be replaced. This mechanism tends to ensure that a PDU Session established on a network slice is transferred to an alternative network slice and which may ensure service continuity, and which might include maintaining a quality of service. The quality of service may be defined in a service level agreement (SLA). The second NF may be an Access and Mobility Management Function “AMF”. The second NF may be a visited Network Slice Selection Function “V-NSSF”. The first network function may comprise a Network Slice Selection Function (NSSF).

The request for notification of when the network slice is to be replaced may also include at least one of: a request for an indication of the alternative network slice which is to replace it; and a first set of network slices for which notification has to be provided, wherein the network slice is a member of the first set of network slices. The first set of network slices may comprise a list of network slices. The first set of network slices may comprise a list of S-NSSAIs. The first set of network slices may comprise any network slice which is served by the second NF.

The notification message received from the first NF may comprise a notification that a network slice is to be replaced also comprise an identification of an alternative network slice to replace it.

The second NF may further comprise determining that a Packet Data Unit “PDU” Session needs to be reallocated to the alternative network slice and transmitting a modification request to a fifth NF.

The PDU session modification request may identify an alternative network slice. The alternative network slice replaces the network slice of a first set of network slices. The fifth NF may be an anchor Session Management Function (SMF which in roaming case with home-routed PDU Sessions is a Home SMF, H-SMF). A PDU session modification request may be sent to the H-SMF when a H-PLMN S-NSSAI has to be replaced with an alternative H-PLMN S-NSSAI.

FIG. 8 illustrates a method 800 for a second network function “NF” to determine a replacement of a network slice, the method 800 comprising: sending 810 a request to a first NF for notification of when a network slice is to be replaced; and receiving 820 a notification message from the first NF comprising a notification that the network slice is to be replaced.

In certain embodiments, the method 800 may be performed by a processor executing program code, for example, a microcontroller, a microprocessor, a CPU, a GPU, an auxiliary processing unit, a FPGA, or the like.

The methods defined herein provide a mechanism by which a second network function, such as an AMF, may be informed of a (temporary) change of a network slice. Such a mechanism improves the operation of a wireless communication network by facilitating a change to an alternative network slice when a network slice of a first set of network slices needs to be replaced. This mechanism tends to ensure that a PDU Session established on a network slice is transferred to an alternative network slice and which may ensure service continuity, and which might include maintaining a quality of service. The quality of service may be defined in a service level agreement (SLA). The second NF may be an Access and Mobility Management Function “AMF”. The second NF may be a visited Network Slice Selection Function “V-NSSF”. The first network function may comprise a Network Slice Selection Function (NSSF).

The request for notification of when the network slice is to be replaced may also include at least one of: a request for an indication of the alternative network slice which is to replace it; and a first set of network slices for which notification has to be provided, wherein the network slice is a member of the first set of network slices. The first set of network slices may comprise a list of network slices. The first set of network slices may comprise a list of S-NSSAIs. The first set of network slices may comprise any network slice which is served by the second NF.

The notification message received from the first NF comprising a notification that a network slice is to be replaced may also comprise an identification of an alternative network slice to replace it.

The method may further comprise determining that a Packet Data Unit “PDU” Session needs to be reallocated to the alternative network slice and transmitting a modification request to a fifth NF. The PDU session modification request may identify an alternative network slice. The alternative network slice replaces the network slice of a first set of network slices. The fifth NF may be an anchor Session Management Function (SMF which in roaming case with home-routed PDU Sessions is a Home SMF, H-SMF). A PDU session modification request may be sent to the H-SMF when a H-PLMN S-NSSAI has to be replaced with an alternative H-PLMN S-NSSAI.

An NSSF as described herein may be arranged to: receive a request for notification (e.g. from consumer NFs like AMF or V-NSSF) of whether one or more network slices (e.g. old S-NSSAIs) are to be replaced with an alternative S-NSSAI and which alternative S-NSSAI value; transmit a request to another NSSF in a H-PLMN (e.g. to H-NSSF) to request a notification for replacement of H-PLMN S-NSSAI has to be replaced; determine (e.g. in the H-NSSF) the alternative S-NSSAI which should replace the old S-NSSAI; transmit a notification to the consumer NFs (e.g. AMF or V-NSSF) that the old S-NSSAI has to be replaced with the alternative S-NSSAI; and determine that the replacement of an old S-NSSAI is not any longer required or that it is terminated; and transmitting a corresponding notification to the consumer NFs.

An AMF as described herein may be arranged to: determine to request notification from the NSSF (V-NSSF or H-NSSF) about the event when any of the served S-NSSAIs (e.g. V-PLMN S-NSSAI, H-PLMN S-NSSAI) has to be replaced by an alternative S-NSSAI; receive a notification (e.g. from the NSSF) that a specific S-NSSAI (e.g. V-NSSAI or H-NSSAI) has to be replaced; transmit PDU Session modification request to the H-SMF in case that the H-PLMN S-NSSAI has to be replaced with alternative H-PLMN S-NSSAI.

Accordingly, there is provided a method for a first network function (NF, e.g. NSSF) to determine a replacement of a network slice, the method comprising: receiving a request from a second NF for notification to determine whether one or more network slices of a first set have to be replaced and by which alternative network slice are to be replaced; determining that at least one network slice from the first set has to be replaced and the alternative S-NSSAI; transmitting a notification message to the second NF comprising at least one of: a notification that a network slice form the first set has to be replaced and the replacement alternative network slice.

Determining that at least one network slice from the first set has to be replaced and the alternative S-NSSAI may comprise transmitting a request for notification to a third NF (e.g. H-NSSF) in a H-PLMN to request a notification for replacement of H-PLMN S-NSSAI has to be replaced.

Determining that at least one network slice from the first set has to be replaced and the alternative S-NSSAI may comprise receiving a notification about the unavailability of the network slice from a fourth NF (e.g. NWDAF, NF or AF).

The second NF may be an AMF or a visited NSSF.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GS, 5 Generation System; 5GC, 5 Generation Core network; AMF, Access and Mobility Management Function; AS, Access Stratum; BS, Base Station; DSCP, Differentiated Services Code Point; eNB, Evolved Node-B; EPC, Evolved packet core; EPS, Evolved packet system; FQDN, Fully-Qualified Domain Name; gNB, 5G Node-B; ID, Identity; IE, Information Element; LTE, Long Term Evolution; NAS, Non Access Stratum; MM, Mobility Management; MO, Mobile Originated; MPS, Multimedia Priority Service; MT, Mobile Terminated; NAS, Non-Access Stratum; NEF, Network Exposure Function; NPN, Non-Public Network; NR, New Radio; NRF, Network Repository Function; NSSAA, Network slice secondary authentication and authorization; NSSF, Network Slice Selection Function; PDCP, Packet Data Convergence Protocol; PDU, Protocol Data Unit; PLMN, Public Land Mobile Network; RA, Registration Area; RAN, Radio Access Network; RAT, Radio Access Technology/Type; SM, Session Management; SMF, Session Management Function; SMS, Short Message Service; SNPN, Stand-alone Non-Public Network; SUCI, Subscription Concealed Identifier; SUPI, Subscription Permanent Identifier; TA, Tracking Area; UDM, Unified Data Management; UCU, UE configuration update; UE, User Equipment; UICC, universal integrated circuit card; UMTS, Universal Mobile Telecommunication System; URL, Uniform Resource Locator; URSP, UE Route Selection Policy; USIM, Universal subscriber identity module; and (E)-UTRAN, (Evolved) Universal Terrestrial Radio Access Network.

What is claimed is:

1-24. (canceled)

25. A first network function (NF) for wireless communication, comprising:
at least one memory; and
at least one processor coupled with the at least one memory and configured to cause the first NF to:
receive, from a second NF, a request to subscribe for notification of replacement of a network slice;
determine that the network slice is to be replaced and determine a replacement network slice; and
transmit, to the second NF, a notification message comprising the notification of replacement of the network slice.

26. The first NF of claim 25, wherein the request from the second NF comprises one or more of:
a request for an indication of the replacement network slice; or
one or more network slices for which notification of network slice replacement is to be provided, wherein the one or more network slices comprise the network slice.

27. The first NF of claim 26, wherein the notification message comprises an indication of an identity of the replacement network slice.

28. The first NF of claim 25, wherein based at least in part on a roaming state, the at least one processor is operable to cause the first NF to:
transmit, to a third NF in a home network, a request for notification of replacement of the network slice.

29. The first NF of claim 25, wherein the at least one processor is operable to cause the first NF to:
receive, from a fourth NF, a notification of unavailability or severe conditions of the network slice.

30. The first NF of claim 25, wherein the at least one processor is operable to cause the first NF to:
determine that the network slice to be replaced may be reused; and
transmit, to the second NF, a notification that the network slice be replaced may be reused.

31. The first NF of claim 25, wherein the first NF comprises a Network Slice Selection Function (NSSF).

32. The first NF of claim 25, wherein the second NF comprises an Access and Mobility Management Function (AMF).

33. The first NF of claim 25, wherein the second NF comprises a visited Network Slice Selection Function (V-NSSF).

34. A method performed by a first network function (NF), the method comprising:
receiving, from a second NF, a request to subscribe for notification of replacement of a network slice;
determining that the network slice is to be replaced and determine a replacement network slice; and
transmitting, to the second NF, a notification message comprising the notification of replacement of the network slice.

35. The method of claim 34, wherein the request from the second NF comprises one or more of:
a request for an indication of the replacement network slice; or
one or more network slices for which notification of network slice replacement is to be provided, wherein the one or more network slices comprise the network slice.

36. The method of claim 35, wherein the notification message comprises an indication of an identity of the replacement network slice.

37. The method of claim 34, further comprising, based at least in part on a roaming state:
transmitting, to a third NF in a home network, a request for notification of replacement of the network slice.

38. A second network function (NF) for wireless communication, comprising:
at least one memory; and
at least one processor coupled with the at least one memory and configured to cause the second NF to:
transmit, to a first NF, a request to subscribe for notification of replacement of a network slice; and
receive a notification message comprising a notification of a replacement network slice.

39. The second NF of claim 38, wherein the request to subscribe for notification of replacement of the network slice comprises one or more of:
a request for an indication of the replacement network slice; or
one or more network slices for which notification of network slice replacement is to be provided.

40. The second NF of claim 39, wherein the notification message comprises an indication of an identity of the replacement network slice.

41. The second NF of claim 38, wherein the at least one processor is operable to cause the second NF to:
determine that a packet data unit (PDU) session is to be reallocated to the replacement network slice; and
transmit a PDU session modification request to a fifth NF.

42. A method performed by a second network function (NF), the method comprising:
transmitting, to a first NF, a request to subscribe for notification of replacement of a network slice; and
receiving a notification message comprising a notification of a replacement network slice.

43. The method of claim 42, wherein the request to subscribe for notification of replacement of the network slice comprises one or more of:
a request for an indication of the replacement network slice; or
one or more network slices for which notification of network slice replacement is to be provided.

44. The method of claim 43, wherein the notification message comprises an indication of an identity of the replacement network slice.
